(19) United States
(12) Patent Application Publication
(10) Pub. No.: US 2009/0015567 A1
(43) Pub. Date: Jan. 15, 2009

(54) Digital Stand Alone Device For Processing Handwritten Input

(76) Inventors: Marwa Abdelbaki, Beirut (LB); Firas Zeineddine, Stonehouse (GB)

Correspondence Address: MAYER BROWN LLP, P.O. BOX 2828, CHICAGO, IL, 60690, US

(21) Appl. No.: 11/688,642

(22) Filed: Mar. 20, 2007

Related U.S. Application Data
(60) Provisional application No. 60/783,891, filed on Mar. 20, 2006.

(51) Int. Cl. G06F 3/033; G06K 9/00; G06F 17/28; G10L 11/00

(52) U.S. Cl. 345/179; 382/188; 704/2; 704/277; 704/E11.001

(57) ABSTRACT

A standalone real time device to process handwritten text for further applications. The system includes a means for making visible markings on writing surface, accompanied with a motion detector for detecting the handwritten text. It also comprises a microprocessor for storing appropriate data and commands, an enhanced memory to provide storage space for information and data, and a power supply. The system further includes a display to provide visual feedback of processed data. Also, it further includes an audio reproduction device to provide audio feedback; and further includes wired or wireless communication means to transmit data to targeted devices via a transmission link in real time.

This application claims the benefit of and priority of prior filed provisional patent application Ser. No. 60/783,891

### FIELD OF THE INVENTION

The invention relates generally to a standalone device that can process handwritten input through various applications in real time. The device is a single portable gadget, and can interact with other devices such as PC or PDA and is preferably embodied as a pen-shaped device.

### BACKGROUND OF THE INVENTION

Although digital pens have achieved considerable popularity and commercial success, there has been a continuing need for improvement. Currently available digital pens can write in ink, and are used to capture pen strokes on paper and digitize them, so that the pen strokes can be converted by handwriting recognition software to a digitally-stored record of the writing. Also, digital pens are used as input devices for target devices (PC, PDA . . . ) in real time using transmission links such as Bluetooth, wire, USB, IrDA or embedded links.

Digital pens are disclosed in U.S. Pat. No. 4,471,218 issued Sep. 11, 1984 to Culp; U.S. Pat. No. 6,744,426 issued Jun. 1, 2004 to Okamoto, et al.; U.S. Pat. No. 6,592,039 issued Jul. 15, 2003 to Smith, et al; and other patents.

Handwriting input detection techniques are disclosed in U.S. Pat. No. 5,793,357 issued Aug. 11, 1998 to Ivey, et al; U.S. Pat. No. 6,924,442 issued Aug. 2, 2005 to Nakano, et al; U.S. Pat. No. 6,927,764 issued Aug. 9, 2005 to Ericson, et al; U.S. Pat. No. 6,592,039 issued Jul. 15, 2003 to Smith, et al.; U.S. Pat. No. 6,330,057 issued Dec. 11, 2001 to Lederer, et al.; and other patents.

Handwriting input recognition techniques are disclosed in U.S. Pat. No. 6,438,523 issued Aug. 20, 2002 to Oberteuffer, et al.; U.S. Pat. No. 6,947,029 issued Sep. 20, 2005 to Katagiri, et al; U.S. Pat. No. 6,947,596 issued Sep. 20, 2005 to Kashioka, et al; U.S. Pat. No. 6,956,969 issued Oct. 18, 2005 to Loudan, et al; and other patents.

It is a general object of the present invention to provide methods and apparatus for processing hand written input in real time for further applications.

It is a further object of the present invention to provide a device which is accurate, reliable and low in cost, and has various considered necessary functionalities.

### SUMMARY OF THE INVENTION

Accordingly, it is an object of the present invention to provide methods and apparatus for processing hand written input in real time for further applications.

Preferably, the proposed apparatus is a pen-shaped device. The device includes an elongated body defining a writing tip, and a motion detector that detects the handwritten text. Also, the device includes a processor that receives signals from the detector and in response thereto carries out the input data through the device's various applications and functionalities. The processor is accompanied with an enhanced memory to store input signals from the processor, and information. Also, the device includes a power source such as rechargeable batteries.

In a preferred embodiment, the detector, processor, memory, and batteries are all supported by the device's body.

Preferably, the detector sends signals to the processor only when the writing tip is positioned against the writing surface, so that when a writer lifts the device from the surface, the signals are not processed. The processor includes a handwriting detection algorithm that inputs signals from the detector. The detected signals are sent to a handwriting recognition module that renders the said signals into alpha-numeric characters. Upon recognition of the character, the algorithm checks if the writer ended writing. If so, the word whether correct or wrong is stored in memory for further processing through the device's applications and functionalities.

According to one aspect of the present invention, the device further comprises at least one mounted display and at least one scroll control for reviewing the information on the display. Also, the processor further comprises a spell checking algorithm. The algorithm processes recognized written text and determines if the written data is correct or not. The input data is compared to a saved dictionary in the device's memory. If the written text is present in the dictionary, then the algorithm determines a ‘correct’ state of the word, and ‘CORRECT’ is displayed on the screen. Else, if the input data is not found in the dictionary, the algorithm determines the possible suggestion(s) and displays the output on the said display.

According to a still further aspect of the present invention, the device further comprises at least one mounted display, and at least one scroll control for reviewing the information on the display. Also, the processor further comprises a dictionary algorithm along with the spellchecking algorithm. Once the recognized input text is checked to be correct, the processor runs the dictionary algorithm to provide possible synonyms. The dictionary algorithm searches the stored dictionary for related synonyms. The synonyms are outputted on the said display. The user can use the scroll control to view all synonyms.

According to a still further aspect of the present invention, the device further comprises at least one mounted display, and at least one scroll control for visually reviewing data. Also, the processor further comprises an auto-completion algorithm. Once the device recognizes the first letter, the processor calls the auto-completion algorithm. The algorithm searches the stored word-list for possible words. While the user is still writing, the algorithm keeps trying to guess the word. The possible words are outputted on the said display. The user can use the scroll control to view all possible words.

According to a still further aspect of the present invention, the device further comprises at least one audio reproduction device and at least one scroll control for aurally reviewing data. Also, the processor further comprises along with the spellchecking algorithm a pronunciation algorithm. Once the recognized input text is checked to be correct, the processor calls the pronunciation algorithm. The pronunciation of the written text is carried on to the said audio device.

According to another aspect of the present invention, the device further comprises at least one mounted display, at least one scroll control for reviewing the information on the display, at least one audio reproduction device and at least one scroll control for aurally reviewing data. Also, the processor further comprises along with the spellchecking algorithm, a translation algorithm. Once the recognized input text is checked to be correct, the processor processes it to the translation algorithm. The processor translates the recognized text into a selected supported language. The algorithm searches for a suitable translation of the input data. The translated text is visually and aurally outputted via the said display and the said audio device respectively.

According to a still further aspect of the present invention, the device further comprises at least one electronic communication port. The device can be used as a storage device. The memory would be large enough to store enough information. Locally stored data would be sent to external devices for further processing. The present invention would be later linked to a targeted device via transmission links such as Bluetooth, IrDA, wire, or embedded links.

According to a further aspect of the present invention, the device could be a combination of any of the above mention applications. In such case, the processor further comprises an algorithm to provide the user with a set of options to choose from as to how to carry on the input data.

The details of the present invention, both as to its structure and operation, can best be understood in reference to the accompanying drawings.

Thus, the device may include one or combination of the mentioned applications.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a schematic view of the device's outer view;

FIG. 2 is a schematic view of the device's inner view;

FIG. 3 is a flowchart illustrating the operation of the device;

FIG. 4 is a block diagram showing the data flow between the main components of the device.

FIG. 5 is a flowchart illustrating the operation of the auto-completion algorithm;

FIG. 6 is a block diagram showing the data flow between the modules involved in the pronunciation operation.

FIG. 7 is a schematic diagram of memory addresses;

### DETAILED DESCRIPTION OF THE INVENTION

Preferably, the present invention is a portable standalone device that can manipulate handwriting through various applications in real time.

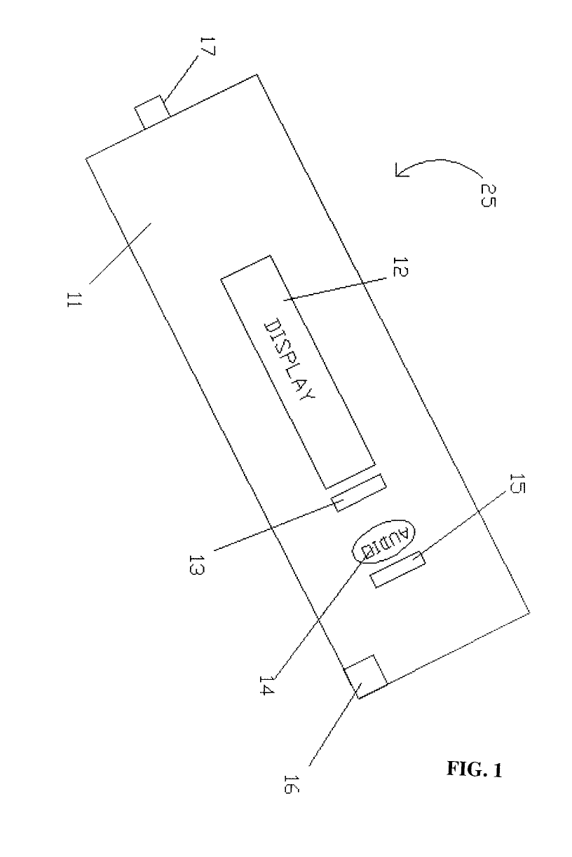

Referring initially to FIG. 1, the device generally designated 25, includes at least one lightweight elongated hollow plastic or metal pen-shaped body 11. The preferred embodiment set forth herein contemplates a body 11 that can be manipulated by a writer to write ink or graphite or other substance onto a surface such as a paper to process handwritten input through various applications in real time.

At least one display 12 can be supported on the device body 11. The display 12 provides a user with visual feedback, such as by echoing entered data, updating status, and displaying requested information. Display 12 can display text and characters, or it may produce graphic presentations or icons, and may employ currently known technologies, such as a cathode ray tube (CRT) or a liquid crystal displays (LCD). The information shown on display 12 is controlled by the microprocessor 22.

A scroll control 13 may also be added to device 25 to allow easy selection of desired data from groups of data entries too long to be reviewed on a single screen presentation by display 12. Scroll control 13 allows the user to scroll through the data/menu options. When not being used, scroll control 13 sits in a neutral or centered position.

In continued reference to FIG. 1, the body 11 may include an audio reproduction device 14. This device 14 may comprise a speaker or speakers, a microphone, and sound recordation means to permit the user to tailor his or her own audio feedback. The device 14 provides audio feedback and allows interactive voice communications. Apparatus 25 may also allow the user to dictate voice messages which may be captured and recorded by the device. The device 25 may employ known speech compression technology to allow greater amounts of recording space for speech in available memory.

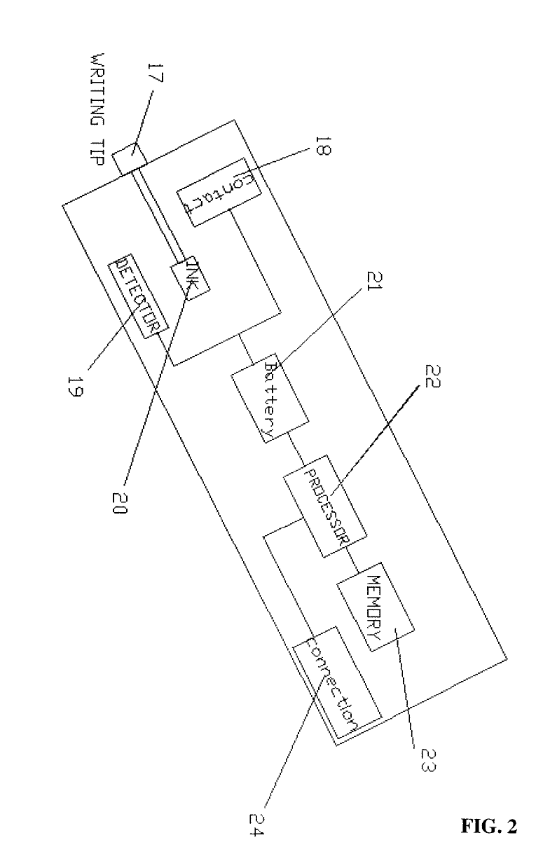

Referring to FIG. 2, a contact sensor 18 can be supported on the device body 11, for purposes to be shortly disclosed. The contact sensor can include, e.g., force sensing resistors or other force sensors. The contact sensor is energized by a power supply 21, preferably a type AAA Nickel Metal Hydride rechargeable battery with voltage step-up electronics. Or, the power supply 21 could be an alkaline battery or other equivalent source. The power supply 21 also energizes a detection tool 19 that is mounted on the body 11. The handwriting detection engine can be any suitable handwriting detection system, such as those disclosed in U.S. patents discussed previously. The detection tool connects to a digital processor 22, which receives the detector's signals and stores them in a digital memory 23. Signals stored in the memory 23 can be transferred to a handwriting recognition engine for correlation of the input signals to alpha-numeric characters. The handwriting recognition engine can be any suitable handwriting recognition system, such as those disclosed in U.S. patents discussed previously. The power supply 21, processor 22, and memory 23 are all mounted on the device body 11 as shown.

In continued reference to FIG. 2, in the preferred embodiment ink is deposited on the writing surface as the writing tip 17 is moved against the surface. Accordingly, an ink supply 20 is mounted on the body 11 in communication with the writing tip 17. Alternatively, the writing tip 17 can deposit graphite or other substance on the surface.

In continued reference to FIG. 2, in the preferred embodiment at least one electronic communication port 24 can be mounted on the body 11. The electronic port can be a wireless communication means, such as an infrared (IR) link, radio frequency (RF) link, or Ethernet link or USB link or other means. Either of these means would be known and understood by a person of ordinary skill in the art and will not be discussed in greater detail herein.

This electronic communication capability 24 along with the use of a battery or batteries 21 as a power source permits apparatus 25 to be completely portable and still allows the device to interact with the external devices. This interaction permits locally entered data to be sent to external devices for further processing.

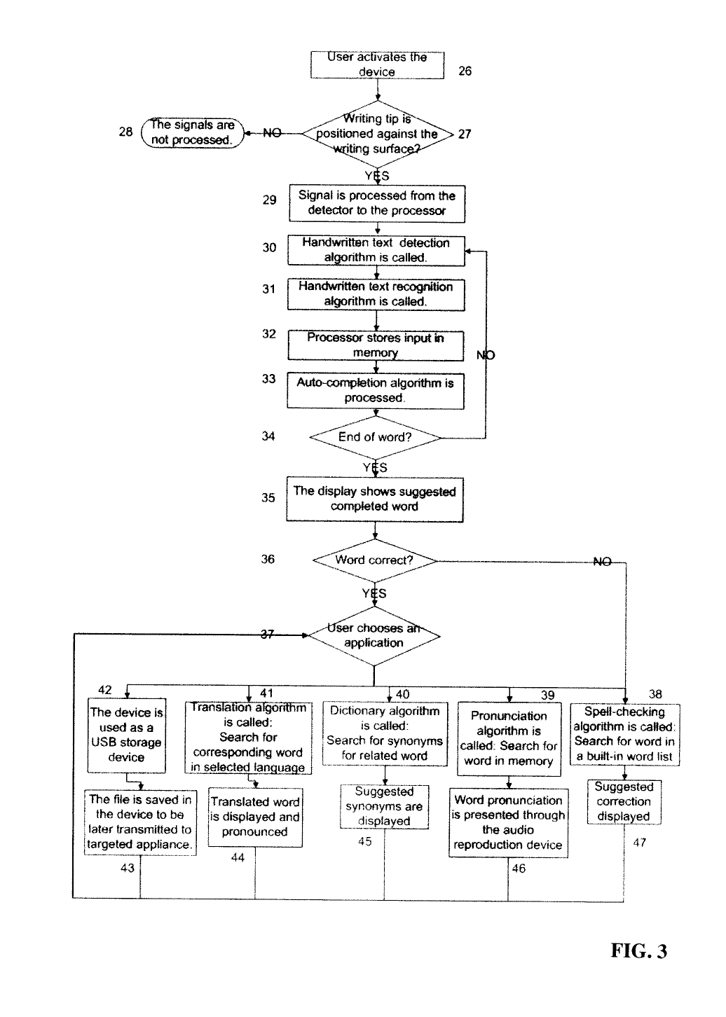

FIG. 3 shows a preferred general overview of the device's operation. Commencing at block 26, the user activates the device with an on/off technique, following in step 27, the contact sensor 18 determines if device 25 is in contact with writing surface. When the device 25 is not in contact with the surface, the process is halted in step 28 and no signals are processed. When the device 25 is in contact with the writing surface, the signals are processed from the motion detector 19 to the digital processor 22 in step 29. The processor 22 transfers the input signals to a handwriting recognition engine 51 in step 31. The recognition engine correlates the input signals to alpha-numeric characters. The recognized characters are stored in the memory in step 32 for further processing.

In a preferred process, when the recognition engine 51 outputs the first recognized letter, the auto-completion algorithm is called in step 33. The algorithm searches for possible words the writer is intending to write. When all letters have not been detected, the process returns to step 30 and detects additional letters. When the writer stops writing and all letters have been detected, the detection algorithm and the recognition algorithm halt and the auto-completion algorithm displays suggested words on the display 12.

In a preferred process, if the output of the auto-completion engine is correct in step 36, the writer uses the scroll control 13 to scroll through the data/menu options in step 37. The user has the choice of five applications to select from: spell-checking in step 38, pronunciation in step 39, synonyms in step 40, translation in step 41 and saving the text in step 42.

In a preferred process, if the suggested auto-completed word is not the one the user intended to write, then the handwritten word goes through the spell-checking algorithm in step 38, and potential corrections are suggested in step 47.

In a preferred process, when the user wants to choose another application regarding the written word, the processor returns to step 36, and displays the menu options.

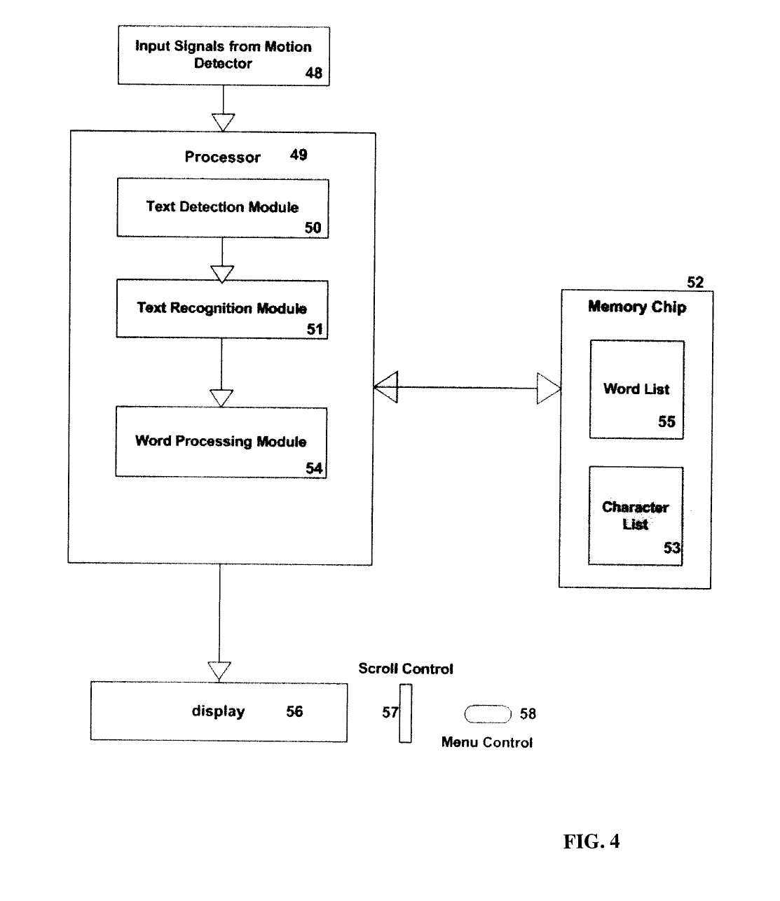

Referring to FIG. 4, the recognized word output by the handwritten text recognition module 51 (step 31 in FIG. 3) is fed one letter at a time to the word processing module 54. The processor 49 looks for the written text in the word list 55 using each input letter to narrow down the list of possible words further, taking advantage of a well-known technique: “divide and conquer” used in the QuickSort algorithm as disclosed in U.S. Pat. No. 5,535,378 issued Jul. 9, 1996 to Arnold. In such a method, the device can find the intended word fast, making use of the fact that the words in memory 52, are stored and located at predictable addresses.

The memory chip 52 stores a word list 55 and a character array 53. The words are arranged alphabetically in ascending order in the word list 55, one language after the other. Preferably, the consecutive letters and words are stored in consecutive memory locations.

In a preferred embodiment and for compression purposes, the words and characters would be stored in memory addresses in a predictable fashion, following a certain simple mathematical function such as hashing functions similar to the ones disclosed in U.S. Pat. No. 4,588,985 issued May 13, 1986 to Carter, et al.

In yet another embodiment, the words in the stored list 55 can be indexed making the search as fast and efficient as possible.

In another aspect of the invention, the device 25 can be conceived for a specific domain; as such the word list 55 would enclose a specialized dictionary associated with the said domain (medical lexicon, computer lexicon, business lexicon . . . ).

The size of the word list and character list depend on the number of languages the device 25 supports and the degree of completeness of the lexicon.

In reference to FIG. 4, and in a preferred embodiment, the word processing module 54 can include a spell-checking algorithm (step 38 in FIG. 3). The handwritten text recognition module 51 inputs recognized characters to the spell-checking algorithm inside the word processing module 54. The device 25 decides whether the written word is spelled correctly or not in real-time. This decision is based on whether the word exists in the list 55, this means it is correct, or not, meaning it was misspelled. In the latter case, the processor 49 will retain the words that are mostly close to it in the way they are spelled and display them on the display 56 as suggested corrections. Using the scroll control 57, the user can go through all the suggestions.

In a preferred embodiment, the spellchecking algorithm can be further enhanced to become context-based. In this case, the device 25 needs to be able to store the whole sentence and not only the word being checked. Furthermore, it would benefit the device to be domain specific because in practice, it would lessen the burden on the processor 49 and the memory chip 52. Such a context-based spell checking algorithm is disclosed in U.S. Pat. No. 6,292,771 issued Sep. 18, 2001 to Haug, et al.

In the present invention, the suggested corrections are displayed on the display 56 in an alphabetical order. In a preferred embodiment and using the context-based algorithm, the best suggestion can be placed in a preferential position on the suggested list as disclosed in U.S. Pat. Pub. No. 20030145285 A1 Pub. Jul. 31, 2003 to Miyahira, Tomohiro; et al.

In continued reference to FIG. 4, and in a preferred embodiment, the word processing module can include a dictionary algorithm (step 40 in FIG. 3). The handwritten text recognition module 51 inputs recognized characters to the dictionary algorithm inside the word processing module 54. The processor 49 can provide synonyms for the word and show them on the display 56. To ensure the operation of the device in real-time, the extraction of synonyms has to be fast. This depends on the way theses synonyms are physically stored inside the memory chip 52. The synonyms are already enclosed by the word list 55 so no need to store them again. However the words in the list are arranged alphabetically so there is a need to relate each word to its synonyms in a many-to-many relationship. One possible way is to store next to each word in the list, pointers to its potential synonyms, so that once it is found, the synonyms can be instantaneously retrieved. One skilled in the art can easily find numerous other ways to rapidly retrieve synonyms using indexing, hashing functions, and other similar means.

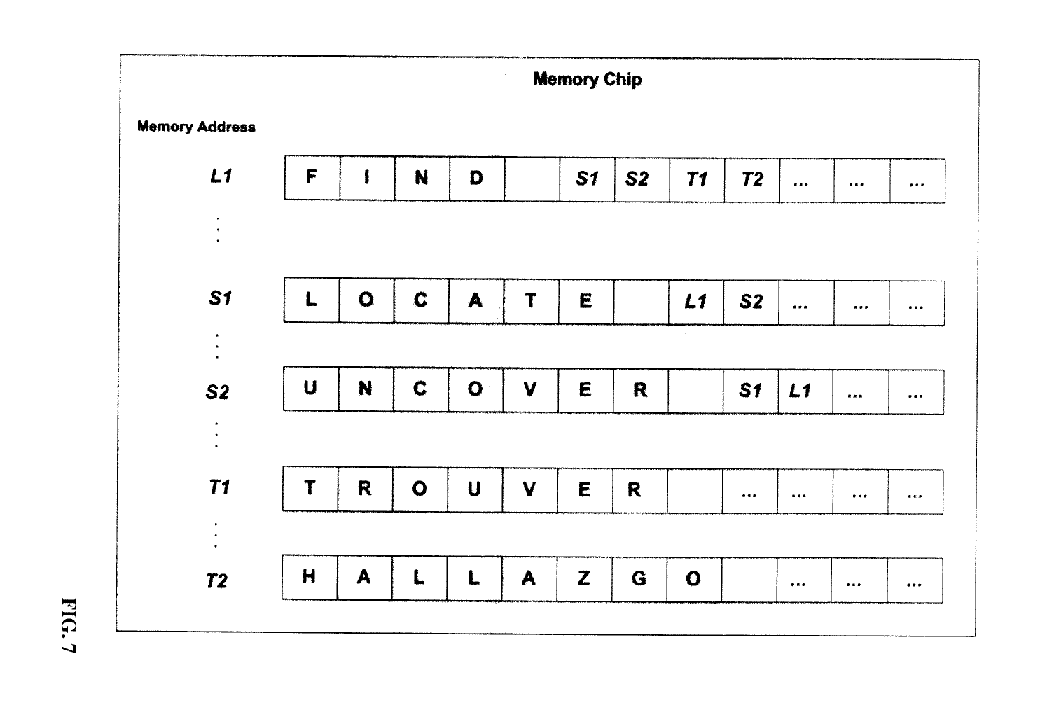

A sample data storage is depicted in FIG. 7. The synonyms of the word “find” are stored in locations having the memory addresses S1 and S2 respectively.

In a preferred embodiment, definitions can be stored in relation to the words, and based on the user's request, they can be shown on the display.

In yet another aspect of the invention, the word list 55 stores words from more than one language. In one simple embodiment, pointers are stored next to each word that point to the memory locations of the potential translations in the different supported languages.

A sample data storage is depicted in FIG. 7. The translations of the word “find” are stored in locations having the memory addresses T1 (French) and T2 (Spanish) respectively

In a better embodiment of the invention whereby a powerful processor is used, the translation can give more accurate results when conducted in the fashion disclosed in U.S. Pat. Pub. No. 20030154068 A1 Pub. Aug. 14, 2003 to Tokuda, Naoyuki, et al.

In continued reference to FIG. 4, and in a preferred embodiment, the word processing module 54 can include a pronunciation algorithm (step 39 in FIG. 3). The handwritten text recognition module 51 inputs recognized characters to the pronunciation algorithm inside the word processing module 54. In this case, the word list 55 also includes word-pronunciation pairs.

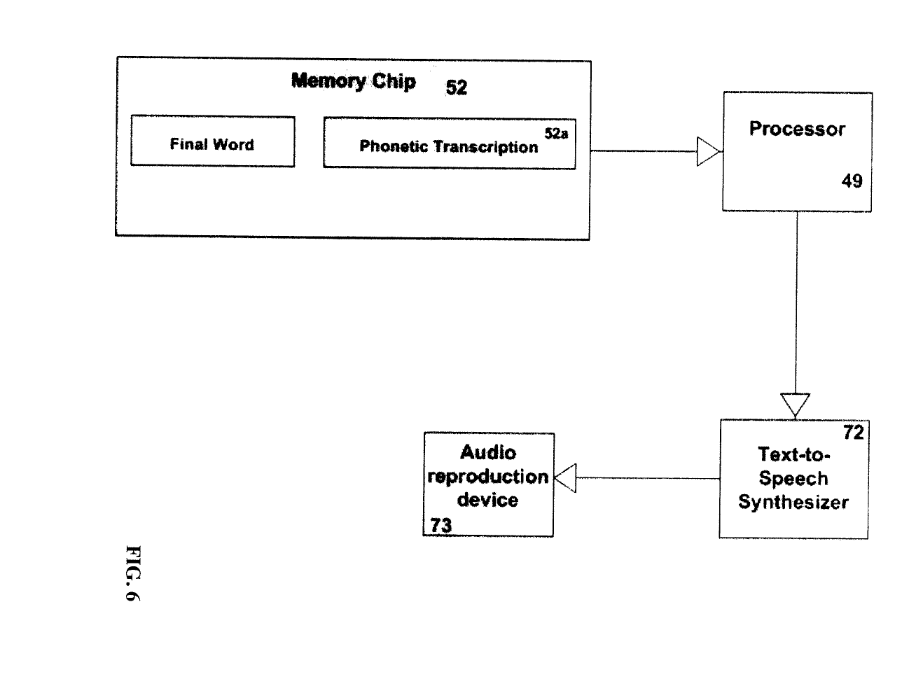

In a preferred method shown in FIG. 6, each word is associated with a certain phonetic transcription 52a. Then, based on the user's request, the processor 49 retrieves the pronunciation pattern corresponding to the written or suggested word. Then, a usual text-to-speech synthesizer 72 will generate speech data for the selected phonetic transcription. This speech data is given to the user through the audio reproduction device 73.

In a better embodiment of the invention whereby a powerful processor is used, the development of word-pronunciation pairs can be conducted similarly to the one disclosed in U.S. Pat. No. 6,363,342 issued Mar. 26, 2002 to Shaw, et al. Such a method can be modified in a way that can be adapted to the present device.

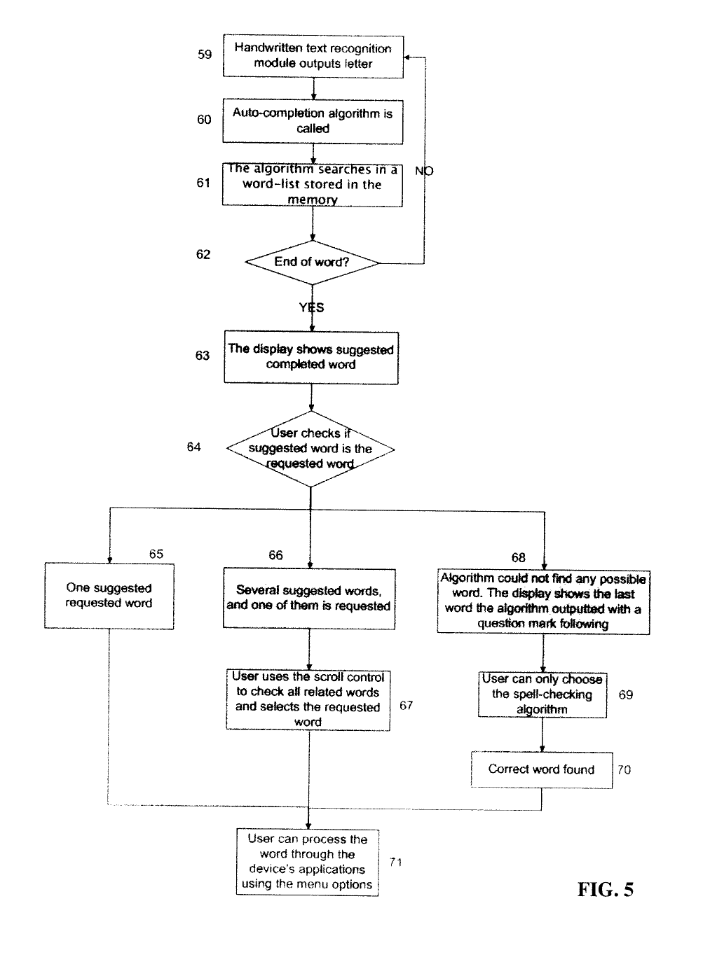

A flow diagram of a preferred process for the auto-completion algorithm (step 33 in FIG. 3) is shown in FIG. 5. The auto-completion engine is called in step 60 upon the recognition of the first letter in step 59. The algorithm searches in a word-list stored in the memory for possible intended words in step 61. While the writer is still writing, the auto-completion algorithm keeps on searching for related words in step 62. Once the engine finds possible words, it displays the output on the display 12 in step 63. The writer can check if the display output is the intended one in step 64. If it is, then the writer can choose any application to process the displayed word in step 71. If other alternatives exist, the writer can use the scroll control 13 to check all suggestions in step 67. Then the writer selects the needed word in step 67 and chooses an application from the menu option to process the word in step 71. In case, the auto-completion engine could not find any related word, the display shows the best suggestion the algorithm could give with a question sign following it in step 68. The user has only one option to choose, that is the spell-checking application to obtain the correct word in step 69. Once the correct word is found, the user can process the word through the device's applications in step 71.

In another aspect of the present invention, the device 25 can be used as a calendar reminder or clock reminder.

In yet another aspect of the present invention, the device 25 can function as a simple calculator by recognizing simple hand written arithmetic operations and displaying the calculated result on the display 12.

What is claimed is:

1. A standalone device to manipulate handwriting comprising:
an elongated writing implement;
a means for making visible markings on a writing surface;
at least one motion detector;
at least one processor to input and analyze data from said detector;
at least one memory;
at least one contact sensor;
at least one dc power source.

2. The device of claim 1, wherein the processor includes logic for recognizing input handwritten text.

3. A standalone device to manipulate handwriting comprising:
an elongated writing implement;
a means for making visible markings on a writing surface;
at least one motion detector;
at least one processor to input and analyze data from said detector;
at least one contact sensor;
at least one dc power source;
at least one mounted display.

4. The device of claim 3 further comprising at least one scroll control for visually reviewing data.

5. The device of claim 3, wherein the processor includes logic for outputting synonyms for recognized text.

6. The device of claim 3, wherein the processor includes logic for predicting the written text prior to its completion.

7. The device of claim 3, wherein the processor includes logic for translating recognized text to different supported languages.

8. The device of claim 3, wherein the processor includes logic for spell-checking recognized text.

9. A standalone device to manipulate handwriting comprising:
an elongated writing implement;
a means for making visible markings on a writing surface;
at least one motion detector;
at least one processor to input and analyze data from said detector;
at least one contact sensor;
at least one dc power source;
at least one audio reproduction device.

10. The device of claim 9 further comprising at least one scroll control for aurally reviewing data.

11. The device of claim 9, wherein the processor includes logic for pronouncing recognized text.

12. The device of claim 9, wherein the processor includes logic for translating recognized text to different supported languages.

13. A standalone device to manipulate handwriting comprising:
a means for making visible markings on a writing surface;
an elongated writing implement;
at least one motion detector;
at least one processor to input and analyze data from said detector;
at least one contact sensor;
at least one dc power source;
at least one electronic communication port for linking said apparatus with external devices.

14. The device of claim 13, wherein the processor includes logic for transmitting input data to targeted devices via transmission links such as Bluetooth, IrDA, wire, or embedded links.
